(19) United States
(12) Patent Application Publication
(10) Pub. No.: US 2024/0362272 A1
(43) Pub. Date: Oct. 31, 2024

(54) MACHINE-LEARNED MULTI-MODAL ARTIFICIAL INTELLIGENCE (AI) MODELS FOR UNDERSTANDING AND INTERACTING WITH VIDEO CONTENT

(71) Applicant: Twelve Labs, Inc., Seattle, WA (US)

(72) Inventors: Seung Joon Lee, Seoul (KR); Raehyuk Jung, Seoul (KR); Seongyun Lee, Seoul (KR); Minjoon Seo, Seoul (KR); Jaehyuk Yi, Seoul (KR)

(21) Appl. No.: 18/647,338

(22) Filed: Apr. 26, 2024

Related U.S. Application Data
(60) Provisional application No. 63/498,776, filed on Apr. 27, 2023.
(60) Provisional application No. 63/592,432, filed on Oct. 23, 2023.

(51) Int. Cl. G06F 16/735; G06F 40/40; G06V 20/40

(52) U.S. Cl. CPC G06F 16/735; G06F 40/40; G06V 20/46

(57) ABSTRACT

A video analysis system receives one or more queries from users of client devices. The video analysis system trains a machine-learned video encoder and/or a decoder coupled to receive video data and a prompt including a user query and generate an output for responding to the user query. A set of video embeddings are generated by extracting frame data, audio data, or text data from the video content, and applying a machine-learned video encoder to the frame data, the audio data, or the text data to generate the set of video embeddings. The video analysis system also generates a set of prompt embeddings representing at least a portion of the query in a latent space. The video analysis system applies at least a component of a machine-learned decoder to the input tensor to generate an output including a set of output embeddings.

### CROSS-REFERENCE TO RELATED APPLICATIONS

This application claims the benefit of U.S. Provisional Patent Application No. 63/498,776, filed on Apr. 27, 2023, and U.S. Provisional Patent Application No. 63/592,432, filed on Oct. 23, 2023, all of which is incorporated herein by reference in their entirety.

### BACKGROUND

A video analysis system manages and analyzes a data store of videos. The video analysis system may perform various tasks, including query retrieval, analysis of the videos, and the like. Typically, a user of the video analysis system submits a query that is a request to identify and retrieve videos that are related to the query. For example, a user may submit a query to the video analysis system of “a guy in a red shirt playing tennis in a court” to request videos that include a man in a red shirt playing tennis in a court. The video analysis system performs a relevance analysis and identifies videos that include segments that relate to the query, for example, videos that includes a man in a red shirt playing tennis in a court. However, since video data typically includes data of various modalities, it is difficult for a model to understand and interact with video content.

### BRIEF DESCRIPTION OF THE DRAWINGS

FIG. 1 is a high-level block diagram of a system environment for a video analysis system, in accordance with an embodiment.

FIG. 2 illustrates an example inference process for generating responses to a user query using a video encoder and a decoder, in accordance with an embodiment.

FIG. 3 is an example of dividing spatial regions in a video frame and corresponding spatial markers, in accordance with an embodiment.

FIG. 4 illustrates an example inference process for generating responses to a user query using a video encoder and a decoder, in accordance with another embodiment.

FIGS. 5A-5D illustrate example screenshots of interaction with the universal video assistant, in accordance with an embodiment.

FIGS. 6A-6B illustrate example screenshots of interaction with the universal video assistant, in accordance with another embodiment.

FIGS. 7A-7C illustrate example screenshots of interaction with the universal video assistant, in accordance with another embodiment.

FIG. 8 illustrates an example inference process for generating responses to a user query using a video encoder and/or a decoder including an alignment model and a large-language model (LLM), in accordance with an embodiment.

FIG. 9 illustrates generating clip descriptions using the video encoder and/or the decoder and generating responses using a LLM, in accordance with an embodiment.

FIG. 10 illustrates example screenshots of chapters generated using the clip description model, in accordance with an embodiment.

FIG. 11 illustrates an architecture of an attention block with multi-head attention, in accordance with an embodiment.

FIG. 12 illustrates a method of generating a response to a query using a video encoder and/or decoder, in accordance with an embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

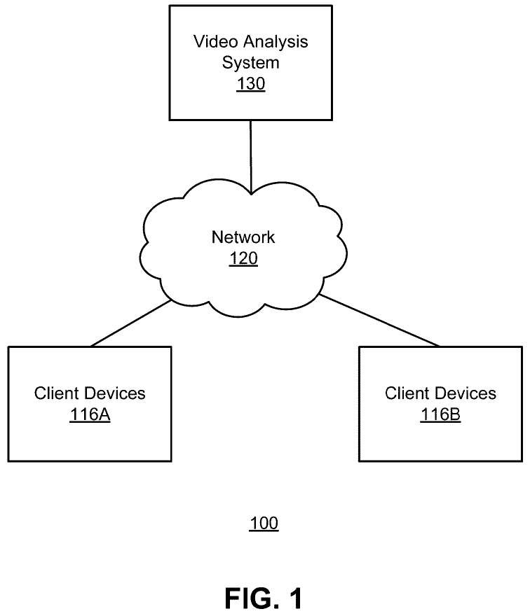

FIG. 1 is a high-level block diagram of a system environment 100 for a video analysis system 130, in accordance with an embodiment. The system environment 100 shown by FIG. 1 includes one or more client devices 116, a network 120, and a video analysis system 130. In alternative configurations, different and/or additional components may be included in the system environment 100.

The video analysis system 130 is system for providing various types of services related to videos to users of client devices 116A, 116B. For example, the video analysis system 130 may manage a collection of videos, where users of the video analysis system 130 can view, retrieve, and share videos managed by the video analysis system 130. The video analysis system 130 may have access to a significant number of videos that when analyzed, provides the video analysis system 130 with insight. For example, the video analysis system 130 may have access to a significant number of reviews by online users that when analyzed, provides the video analysis system 130 with insight into preferences of users.

The video analysis system 130 may receive requests from the client devices 116 to perform various types of tasks on the videos of the video analysis system 130. For example, the video analysis system 130 may perform sentiment classification on video reviews to identify positive or negative reviews for a video. Based on the classification results, the video analysis system 130 may also recommend videos to users associated with positive reviews. As another example, the video analysis system 130 may provide and present statistics on the videos. It is advantageous to understand and interact with the content of a video in a holistic manner in order to fulfill queries that request a variety of tasks and where the desired responses are in different data modalities than video. However, video data is typically composed of multiple data modalities within a single format, such as image data, text data, audio data, and it is challenging to analyze videos.

The video analysis system 130 deploys a universal assistant for videos that is configured to receive user queries and one or more videos and synthesize responses to the user queries using a machine-learned video encoder and/or decoder. In one embodiment, the universal video assistant is configured as a chatbot application that is coupled to receive one or more videos, one or more user queries related to the videos. The query may include a request to perform an inference task and contextual information that provides additional context on the query. The universal video assistant generates and outputs one or more responses to the requested queries. In one instance, the responses may be formulated as textual responses, image responses, audio responses, video response, and/or any other appropriate data modality to formulate a response to the original query.

During an inference process, the video analysis system 130 receives one or more queries from users of client devices 116A, 116B. For example, a user may submit a query to the video analysis system 130 to synthesize one or more responses to the query based on the content of a video. For example, a user query may designate a static or live feed video capturing a patient in a hospital room, and request that the universal video assistant “Watch over the patient Elizabeth and let me know how the patient's status is every hour.” The user query may also specify the image of the patient's face. The universal video assistant may generate one or more responses every hour describing the status of the patient. As an example, at the first hour, the output may indicate “Elizabeth had lunch.”

Therefore, in one embodiment, the video analysis system 130 trains a machine-learned video encoder and a machine-learned decoder coupled to receive video data and a prompt including a user query and generate an output for responding to the user query. In one embodiment, the video analysis system 130 identifies one or more video clips in the video. Each video clip may include a segment of the video. The video analysis system 130 obtains a set of video embeddings representing the video content of a video clip in a latent space. The set of video embeddings are generated by extracting frame data, audio data, or text data from the video content, and applying a machine-learned video encoder to the frame data, the audio data, or the text data to generate the set of video embeddings.

The video analysis system 130 also generates a set of prompt embeddings representing at least a portion of the query in a latent space. The set of prompt embeddings and a set of input embeddings are combined to generate an input tensor. The video analysis system 130 applies at least a component of a machine-learned decoder (e.g., machine-learned alignment model or LLM) to the input tensor to generate an output including a set of output embeddings. The video analysis system 130 converts the set of output embeddings into a response based on the content of the video clip. The video analysis system 130 provides the response to a user of the client device.

In one embodiment, the architecture described herein processes videos of diverse lengths, from brief 10-second clips to extensive multi-hour videos. Moreover, the architecture is able to synthesize multi-modal information, including visual, audio, and speech information. Compared to image-native embeddings (e.g., CLIP model) that focus solely on spatial relationships, the video embeddings generated herein can incorporate both spatial and temporal information of a video in a holistic manner. Moreover, beyond image-text alignment, the architecture described herein can undergo deep video-language alignment based on training on large-scale video-text corpuses and instruction datasets. A more detailed description of the process of inference and training of the video encoder and/or the decoder is provided in conjunction with the figures below.

Returning to the system environment 100 of FIG. 1, the client devices 116A, 116B are computing devices that display information to users and communicates user actions to the video analysis system 130. While two client devices 116A, 116B are illustrated in FIG. 1, in practice many client devices 116 may communicate with the video analysis system 130 in environment 100. In one embodiment, a client device 116 is a conventional computer system, such as a desktop or laptop computer. Alternatively, a client device 116 may be a device having computer functionality, such as a personal digital assistant (PDA), a mobile telephone, a smartphone or another suitable device. A client device 116 is configured to communicate via the network 120, which may comprise any combination of local area and/or wide area networks, using both wired and/or wireless communication systems.

In one embodiment, a client device 116 executes an application allowing the user of the client device 116 to interact with the video analysis system 130. For example, a client device 116 executes a browser application to enable interaction between the client device 116 and the video analysis system 130 via the network 120. In another embodiment, the client device 116 interacts with the video analysis system 130 through an application programming interface (API) running on a native operating system of the client device 116, such as IOS® or ANDROID™.

The client device 116 allows users to perform various actions on the video analysis system 130. In one embodiment, users of client devices 116 can submit queries to the video analysis system 130 to request synthesis of one or more responses to a query based on the content of a video in one or more data modalities. For example, the client device 116 may generate an interface for the user to submit the query, and responsive to receiving the query from the user, provide the query to the video analysis system 130. In addition, responsive to receiving a response from the video analysis system 130, the interface may present the response to the user.

### Example User Queries for Universal Video Assistant

The following are example use cases for the universal video assistant for the sake of illustration. In one instance, a summarization task can be performed to create descriptions for one or more portions (e.g., clips, sub-clips of the video) and/or the entire video content. Example user queries to the universal video assistant may be:
“Write me a synopsis for this video.”
“Write me a 3-sentence summary for this video.”
“Write me a media file name for this video.”
“Can you summarize all the roadblocks the customer said in the meeting?”

In one instance, a chapterization task can be performed to divide the video sub-clips and/or output time markers corresponding to the sub-clips based on the inference task or instruction and write a description for each sub-clip. Example user queries to the universal video assistant may be:
“Can you watch over this patient and let me know the status of the patient's movements every hour?”
“Give me a style of chapter names and timecodes.”
“Divide the video into instructions.”
“Give me all the timecodes where the scene is visually changing.”
“Can you summarize my dog's day for me in 5 key moments?”
“Tell me when something unusual happens between 1 pm to 2 pm (anomaly detection).”

In one instance, an extraction task can be performed to output a set of tags from the videos based on the instruction in the user query. Example user queries to the universal assistant may be:
“Give me all the objects that appeared between 1:56 and 2:10.”
“Create me a review card for the core concepts that appeared in this lecture.”
“Tell me all the logos that appeared in the video.”
“List all the celebrities that appeared in the video.”

In one instance, an in-video question answering task can be performed to generate an answer to a question about the video that may not require external knowledge. Example user queries to the universal video assistant may be:
“Does this video contain violence?”
“Is this a backflip or a frontflip?”
“How many times this person smile during the meeting?”
“How long did this man wait in front of the store?”
“How is my puppy doing at home?”
“Any sensitive things in the videos?”

In one instance, an open question answering task can be performed to generate an answer to the question about the video content that the universal video assistant can answer with an external knowledge base. Example user queries to the universal video assistant may be:
“Tell me all the restaurants and cafes that appeared in this vlog.” The universal video assistant may retrieve external map information to answer the locations of the restaurants cand cafes that appeared in the vlog.
“How much is the chair that appears at 4:30? Where can I buy it?” The universal video assistant may look up the product and price of the chair from the Internet and formulate an answer based on the retrieval.
“Is it legal for the car to take a left turn at 11:20?” The universal video assistant may look up a regulation book from an external storage to formulate the response.

In one instance, a classification task may be performed to categorize the video based on the instruction in the user query. Example user queries to the universal video assistant may be:
“Classify this video into one of following categories:
sports, media, movies, others.”
“Categorize the videos into one of 39 IAB categories.”
“Chat: Exchange opinions about the video.”
“What do you think about the interview with the BBC?”
“Do you think the video is helpful?”
“What did you think about the video?”
“Hey, watch this episode of a drama. What are some compelling advertisements to this type of drama?”

It is appreciated that in other embodiments, the video analysis system 130 may deploy other use cases for the universal video assistant other than the examples described above.

Generating Responses to User Queries Using Video Encoder and/or Decoder

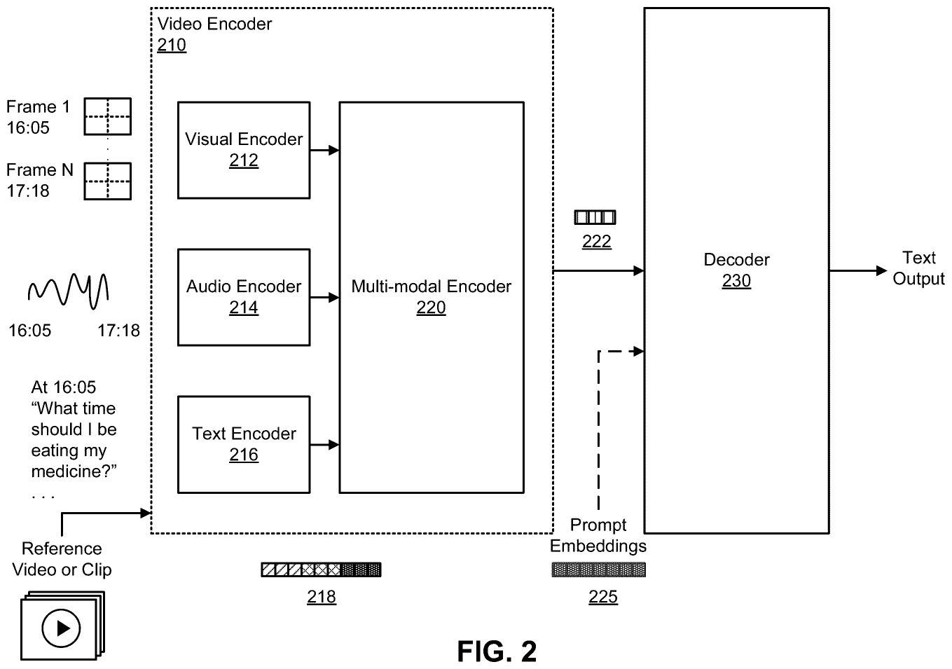

FIG. 2 illustrates an example inference process for generating responses to a user query using a video encoder 210 and/or a decoder 230, in accordance with an embodiment. In one embodiment, the video encoder 210 includes a visual encoder 212, an audio encoder 214, a text encoder 216, and a multi-modal encoder 220. However, it is appreciated that in other embodiments, the video encoder 210 and/or the decoder 230 may include fewer or more components than that illustrated in FIG. 2.

In one embodiment, at least one component of each of the video encoder 210 and/or the decoder 230 is configured as a machine-learned transformer architecture. In one embodiment, a component is one or more layers of a neural network making up the video encoder or the decoder. A transformer architecture is a neural network model that includes one or more attention layers. The attention layers may include cross-attention layers or self-attention layers. The attention layer is coupled to receive queries, keys, and values, and generate attention outputs. Often times, the transformer architecture is a large-scale deep neural network with at least 1 billion, 10 billion, 100 billion, 1 trillion parameters that are trained during a training process.

The video analysis system 130 obtains the video data of a video or video clip. For example, a video may be a live or static feed of a patient Elizabeth in a hospital room. In one embodiment, video data includes frame data, audio data, and/or text data. A frame may be represented as an image tensor, including a group of pixels. The image tensor may have a width dimension, height dimension, and a channel dimension. A location in the frame or image tensor corresponds to a pixel and values of the pixel across the channel dimension. The sequence of frames in the video when played makes an animation. Each frame may be associated with a time stamp of when the frame occurred within the video. The audio data may be represented as a waveform that capture sound amplitude signals across time. The signals may be associated with a time stamp of when the sound occurred within the video. The text data may be, for example, a transcript or caption of a video, automatic speech recognition (ASR) extracted from the video clip, optical character recognition (OCR) extracted from the video clip, and may be represented as one or more tokens that encode different text units (e.g., word, sub-phrase, phrase) with respect to a dictionary.

In one embodiment, the video encoder 210 is coupled to receive the frame data, audio data, and/or text data of a video or video clip and generate a set of video embeddings 222 numerically representing the video or video clip in a latent space. An embedding as defined herein is a multi-dimensional tensor that represents a unit of encoding. For example, one video embedding representing a frame may be a 1×H, where H is the dimensionality of the latent space. The purpose of the video encoder 210 is to glean intricate details from video content by assessing input data and their temporal relationships to obtain relevant visual information while concurrently processing audio signals and speech information.

In one embodiment, the video encoder 210 includes a visual encoder 212, an audio encoder 214, a text encoder 216, and/or a multi-modal encoder 220. The visual encoder 212 is coupled to receive a sequence of frames and generate a set of visual embeddings that encode the visual information in the frames. As shown in FIG. 2, a video clip includes a sequence of frames, Frame 1, . . . , Frame N from time stamps 16:05 to 17:18. In one embodiment, the video analysis system 130 also samples one or more patches within a frame that each correspond to a respective region of pixels in the frame. The visual encoder 212 is also coupled to receive sampled patches within each frame and generate the visual embeddings. As shown in FIG. 2, the video analysis system 130 may sample four patches within each frame. Thus, the set of visual embeddings may encode local visual information in each patch in addition to the frame. For example, the visual embeddings may include 1 clip-level embedding (of 2048 dimensions), 8 frame-level embeddings (of 2048 dimensions), and 64 patch-level embeddings (2048 dimensions). The visual encoder 210 may be configured as a convolutional neural network (CNN), transformer architecture, or any other model configured to process images or frame data. The audio encoder 214 is coupled to receive an audio signal and generate a set of audio embeddings that encode the audio information. As shown in FIG. 2, the audio signals from the video clip captures the sounds occurring in the hospital room for time stamps 16:05 to 17:18. The audio encoder 214 may be configured as a transformer architecture or any other model configured to process soundwave data.

The text encoder 216 is coupled to receive one or more tokens representing text and generate a set of text embeddings that encode the textual information. As shown in FIG. 2, the text form the video clip captures the transcribed text of the people in the video talking in the hospital room for time stamps 16:05 to 17:18. The text encoder 216 may be configured as a transformer architecture of any other model configured to process text data.

The multimodal encoder 220 is coupled to receive the set of visual embeddings, the set of audio embeddings, and the set of text embeddings, and generate the set of video embeddings 222. Therefore, the multi-modal encoder 220 effectively incorporates multi-modal information from the individual modality encoders to generate the set of video embeddings 222. In one instance, the multi-modal encoder 220 is configured as a transformer architecture. For example, the set of video embeddings 222 may include 50 multi-modal embeddings (of 1280 dimensions).

The video analysis system 130 also receives a user query and generates a prompt to the decoder 230. For example, the query may be “Watch over the patient and let me know how the patient's status is every hour.” The prompt includes at least a portion of the user query but may differ from the user query by including additional context or instructions to the decoder 230 that was not included in the original query from the user. The video analysis system 130 converts the prompt into a set of prompt embeddings 225 in a latent space. In one embodiment, the query may include different data modalities, including text data, visual data (e.g., images), and the like. The set of prompt embeddings 225 are generated by at least applying a visual encoder to the visual data in the prompt, applying an audio encoder to the audio data in the prompt, and applying a text encoder to the text data in the prompt, similar or identical to the functionalities of the visual encoder 212, the audio encoder 214, and/or the text encoder 216.

In one embodiment, the video analysis system 130 combines the set of prompt embeddings 225 with the set of video embeddings 222 to generate a combined tensor. In one embodiment, the set of prompt embeddings 225 are concatenated to the set of video embeddings 222 to generate a concatenated tensor. In another embodiment, the set of prompt embeddings 225 are interleaved with the set of video embeddings 222 to generate an interleaved tensor.

The decoder 230 is coupled to receive the set of video embeddings 222 and the set of prompt embeddings 225 and generate an output (e.g., text output) for responding to the user query. In one embodiment, the decoder 230 is coupled to receive the combined tensor as one tensor and applies the parameters of the decoder 230 to generate the output. In one embodiment, the output includes a set of output embeddings that can represent text, visual, audio data. The video analysis system 130 applies a neural network to transform the set of output embeddings into a response. As an example, the text output may be “Elizabeth just had lunch.”

### Rule Indicators

In one embodiment, the universal video assistant is also configured to receive rule indicators that that specify rules that the output should abide by when synthesizing the responses. In one instance, a rule indicator may specify that the output be formulated to use a time marker to refer to a specific time frame in the video. In one instance, a rule indicator may specify that the output be formulated to use a spatial marker to refer to a specific location or region within the video. In one instance, a rule indicator may specify that the output be formulated to be verbose if possible. In one instance, a rule indicator may specify that the output be formulated to be in a professional tone.

In one embodiment, when a rule indicator specifies the use of time markers, the time marker is represented in a “hh:mm:ss” format, where “hh” is the hour, “mm” is the minute, and “ss” is the second of the video (“00:04:35”). The duration of a time frame may be represented as hyphen (“03:11-03:45”).

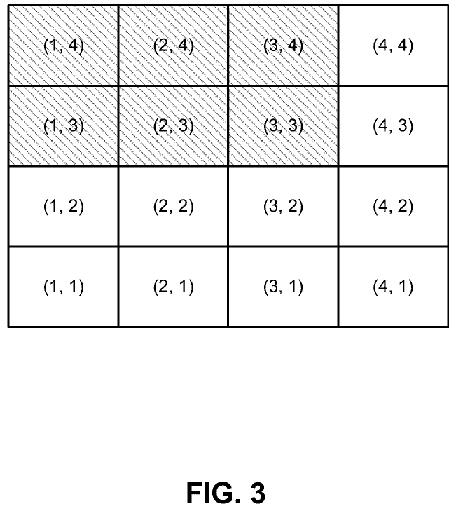

FIG. 3 is an example of dividing spatial regions in a video frame and corresponding spatial markers, in accordance with an embodiment. In one embodiment, when a rule indicator specifies the use of spatial markers, the spatial marker is represented by segmenting the frames of the video into different regions and labeling reach region of the video. For example, as shown in FIG. 3, the video may be divided into 16 regions, including regions (1, 4) through (4, 1). The spatial marker can be represented using a hyphen to refer to larger regions. For example, as shown in FIG. 3, the shaded region can be represented using spatial marker “(1, 3)-(3, 4).” As another example, the regions of the video can be labeled sequentially from 1 through 16.

Therefore, for such rule indicators, the input data of a video or video frame may be associated with time or spatial markers, such that the output of the inference process can refer to such markers in the video. For example, a frame may be associated with a time marker depending on the time of the frame, and a patch in the frame may be associated with a spatial marker depending on the location of the patch within the frame.

Therefore, for such rule indicators, the input data of a video or video frame may be associated with time or spatial markers, such that the output of the inference process can refer to such markers in the video. For example, a frame may be associated with a time marker depending on the time of the frame, and a patch in the frame may be associated with a spatial marker depending on the location of the patch within the frame. Returning to the example above, the response from the output may further specify “Elizabeth had lunch at 00:16:45 on (3, 3)-(4, 4),” where 00:16:45 refers to a time marker in the video clip of when Elizabeth had lunch, and (3, 3)-(4, 4) are spatial markers corresponding to regions in the video clip that capture Elizabeth having lunch.

### Hierarchical Generation of Outputs

In one embodiment, the video analysis system 130 generates responses in a hierarchical manner. Specifically, the video encoder 210 is coupled to receive video data of an entire video and generate a set of video-level event embeddings of the video by, for example, applying the visual encoder, the audio encoder, and the text encoder to the respective data modalities of the video content. For example, one embedding may be generated every 5-30 seconds of the video. The video-level embeddings may be event embeddings in the sense that a collection of one or more event embeddings may correspond to a distinct event or scene in the video. For example, a video may be an approximately two-hour movie of the movie Matrix, and the original user query may be “How many kicks does Neo do in this movie?” A first event embedding encodes a scene where Neo and Trinity meet, a second event embedding encodes a scene where Neo takes a red pill, and the like, and the N-th event embedding encodes a scene where Neo beats Agent Smith.

The video analysis system 130 may apply the multi-model encoder 220 to the set of event-level embeddings and generate a set of video embeddings. The video analysis system 130 may apply the decoder 230 to the set of video embeddings and the set of prompt embeddings incorporating the user query to identify a list of potential video clips to review more closely. Therefore, a list of clips may be identified from the output of the decoder 230. Specifically, the response synthesized from the output may specify “I think there are fighting scenes at clips 00:11:40-00:11:50, 00:20:47-00:25:47, 00:55:40-00:55:35. Let's look at the scenes in these clips first.” Thus, the list of video clips includes a first clip from 00:11:40-00:11:50, a second clip from 00:20:47-00:25:47, and a third clip from 00:55:40-00:55:35 of the movie.

Subsequently, the video analysis system 130 generates outputs for each identified video clip to respond to the user query. Specifically, the video encoder 210 is coupled to receive the video data of the first clip and generate a set of clip-level embeddings of the video by, for example, applying the visual encoder, the audio encoder, and the text encoder to the respective data modalities of the video content of the clip. The clip embeddings densely represent the contents of the video clip and may also include embeddings for patches that encode the different patches of the frame data of the video clip.

The video analysis system 130 may apply the multi-model encoder 220 to the set of clip-level embeddings and generate a set of video embeddings. The video analysis system 130 may apply the decoder 230 to the set of video embeddings and the set of prompt embeddings (e.g., representing prompt “This is the first clip to look at. Are there any kicks?”) incorporating the user query to generate a response to the user query based on the content of the video clip. The response from the output may specify that “No. I don't think there is any kicks in this clip. Go to the next one.”

The video encoder 210 is coupled to receive the video data of the second clip and generate a set of clip-level embeddings of the video clip. The video analysis system 130 may apply the multi-model encoder 220 to the set of clip-level embeddings and generate a set of video embeddings. The video analysis system 130 may apply the decoder 230 to the set of video embeddings and the set of prompt embeddings (e.g., representing prompt “This is the second clip to look at. Are there any kicks?”). The response from the output may specify that “Yes. The first kick happens at 00:20:50 . . . . The 11th kick happens at 00:25:40. Thus, there are a total of 11 kicks in this clip.”

A similar process can be performed for the third identified clip, which has 5 kicks in the video. The final output synthesized for the reference video is then “There is a total of 16 kicks happening in this movie.”

If the video analysis system 130 processed every frame within the video, it would be inefficient and computationally burdensome, since even 30 frames per second (fps)×60 seconds(s)×60 minutes (m)×2 hours (h)× 256 patches would amount to 55 million embeddings. Therefore, by hierarchically processing the video to output a list of event embeddings that represents a high-level story and synopsis of the video, and identifying potential clips to review closely helps to save computational resources on clips that are relevant to the user query, rather than redundantly using computing resources on irrelevant content.

### Training Process of Video Encoder and Decoder

In one embodiment, the video analysis system 130 trains parameters for the video encoder and/or the decoder using training data. In one embodiment, for a reference video, the training data includes one or more training instances. A training instance generated for the video includes inputs and outputs. The input for the training instance includes the reference video or a reference video clip and a user query submitted for the video. The output for the training instance includes the expected or desired response to the user query given the contents of the reference video or video clip.

In one embodiment, the video analysis system 130 obtains the training data based on the type of user query (e.g., type of inference task) the video encoder and/or the decoder is being used for. For example, for a characterization task, a training reference video may be a video feed capturing a patient in a hospital. The input may also include a prompt “Watch over the patient and let me know the status every hour. Here is the patient's image <image of patient>,” where the <image of patient> is also attached as an image to the training instance. The training instance may also include a video clip. A desired output may be “The patient had lunch at 00:13:00 on (2, 3)-(3, 3).” For another video clip in another training instance, a desired output may be “A woman and a girl visited the patient at 00:14:00 on (1, 1)-(2, 2).”

The video analysis system 130 performs the training process over one or more iterations. At each iteration, a forward pass step is performed, and a backpropagation step is then performed to update the parameters. The video analysis system 130 initializes parameters of the video encoder and/or the decoder. For a forward pass step, the video analysis system 130 applies the video encoder to a video clip of a training instance to generate a set of video embeddings. The video analysis system 130 applies the decoder 230 to the set of prompt embeddings for the training instance and the set of video embeddings to generate an estimated output. The estimated output may include a set of estimated output embeddings.

The video analysis system 130 computes a loss function that indicates a difference between the estimated output and the desired output for the training instance. During the backpropagation step, the video analysis system 130 obtains one or more terms from the loss function and backpropagates the terms to update parameters of the video encoder and/or the decoder. This process is repeated for other training instances and other reference videos in the training data until a convergence criterion is reached.

In one embodiment, the parameters of the individual modality encoders, such as the visual encoder 212, the audio encoder 214, the text encoder 216 are frozen or unchanged during the training process. The parameters of the individual modality encoders are pre-trained in a separate process. Therefore, during the backpropagation steps, only the parameters of the multi-modal encoder 220 and/or the decoder 230 are updated during the training process.

In one embodiment, the training data is constructed such that the training instances are associated with one or more rule indicators. In one instance, training instances for a particular rule indicator includes a positive example that is a desired output for the training instance and a negative example that is an output not desired for the training instance given the rule indicator.

For example, for a rule indicator to be verbose in the response, the training reference video may be for a movie and the query may be “Why does everyone panic at the beginning?” The positive example for a training instance may be “I believe you are talking about people panicking during 00:00:30-00:01:36. This is because the two sailors, one at (2, 3) and the other at (3, 2), found a big iceberg at 00:00:05. The iceberg appears at 00:00:07, at (2, 2)-(3, 3). If the ship hits the iceberg, it is very likely that the ship will sink. So, the sailors are trying to change the ship's direction so that the ship would not hit the iceberg.” The desired output includes a detailed explanation of the response. On the other hand, the negative example may recite “It is because iceberg at 00:00:07, (2, 2)-(3, 3) is about to hit the ship.” The output is a less verbose version of the response.

As another example, for a rule indicator to use time markers and spatial markers in the response, the training reference video may be for a recipe video to make cookies and the query may be “Show me in which second of the video we can see the different types of sugar being used.” The positive example for a training instance may recite “The video introduces three sugar types at 00:00:33-00:00:41. The first sugar type is white sugar, appearing at 00:00:35 on (1, 2)-(1, 3). The second sugar type is light brown sugar, which appears at 00:00:37 on (2, 2)-(3, 3). The last sugar type, dark brown sugar, appears at 00:00:38 on (4, 2)-(4, 3).” The desired output includes specific time and spatial markers of when the sugars appear in the video. On the other hand, the negative example may recite “The video introduces three sugar types. The first sugar type is white sugar. The second sugar type is light brown sugar. The last sugar type is dark brown sugar.”

As yet another example, for a rule indicator to generate responses in a professional tone, the training reference video may be a video of a professional speaker on cars and the query may be “Tell me the name of the speakers and where to find more of his content.” The positive example for a training instance may be “The name of the speaker is Mat Watson. His name appears at 00:00:10 around (3, 4)-(4, 4). It is not clear which channel this video is coming from, but you can probably find more of his image contents on his social media account. His ID is @matwatsoncars. It appears right below his name at 00:00:10 as well.” The negative example may recite “There is this guy called Mat Watson, appearing at 00:00:10 and (3, 4)-(4, 4), who looks handsome and stylish. He has a social media account @matwatsoncars. I want to follow him too.”

In one embodiment, the loss function is configured such that the loss is increased for the negative examples of a training instance, and the loss is decreased for the positive examples of the training instance (when the desired parameters are to reduce the loss function). In this manner, the parameters of the video encoder and/or decoder are learned to resemble more of the responses in the positive examples and resemble less of the responses in the negative examples for given rule indicators.

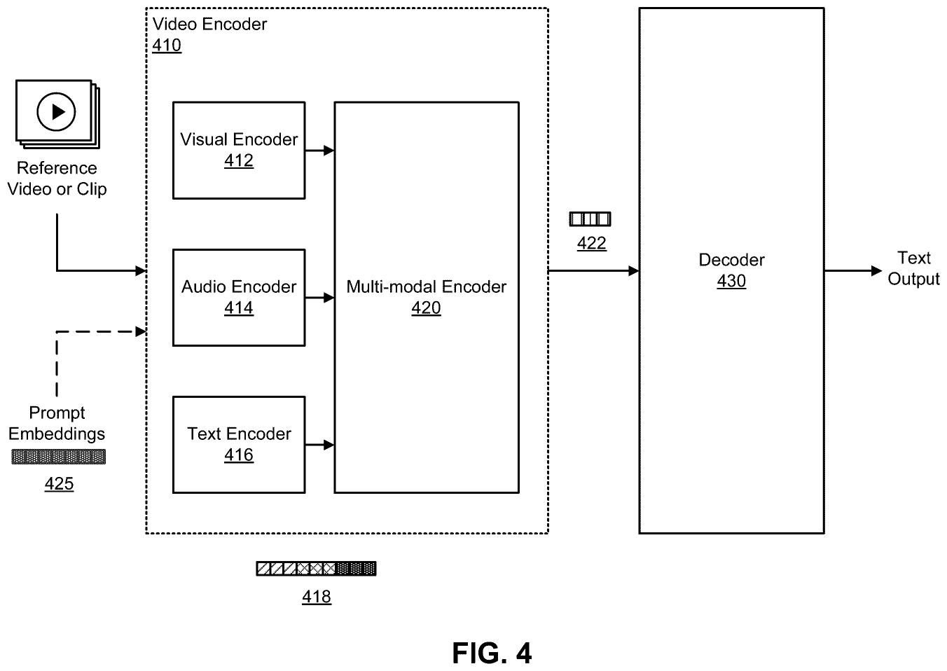

FIG. 4 illustrates an example inference process for generating responses to a user query using a video encoder 410 and a decoder 430, in accordance with another embodiment. In one embodiment, the video encoder 410 includes a visual encoder 412, an audio encoder 414, a text encoder 416, and a multi-modal encoder 420. However, it is appreciated that in other embodiments, the video encoder 410 and/or the decoder 430 may include fewer or more components than that illustrated in FIG. 4. The video encoder 410 may be configured substantially similar or identical to the video encoder 210 of FIG. 2. The decoder 430 may be configured substantially similar or identical to the decoder 230 of FIG. 2.

Different from FIG. 2, the video encoder 410 is coupled to receive the input data for a video or video clip and the set of prompt embeddings 425 and generate the set of video embeddings 422. Therefore, in the embodiment of FIG. 4, the set of prompt embeddings are processed by the multi-model encoder 420 with the set of individual modality embeddings.

In one embodiment, the video analysis system 130 combines the set of prompt embeddings 425 with the set of visual embeddings, the set of audio embeddings, and the set of text embeddings to generate a combined tensor. In one embodiment, the set of prompt embeddings 425 are concatenated to the visual embeddings, the audio embeddings, and/or the text embeddings to generate a concatenated tensor. As an example, the set of prompt embeddings 425 are concatenated with the input tensor 418 including the visual embeddings, the audio embeddings, and/or the text embeddings as a single tensor. In another embodiment, the set of prompt embeddings 425 are interleaved with the visual embeddings, the audio embeddings, and/or the text embeddings to generate an interleaved tensor. The video analysis system 130 applies the multi-modal encoder 420 to the combined tensor (e.g., as one tensor) to generate the set of video embeddings 422. The decoder 430 is coupled to receive the set of video embeddings 422 and generate an output for responding to the user query.

The training process may be substantially similar or identical to the process described with respect to FIG. 2. For a forward pass step, the video analysis system 130 applies the video encoder to the input data of a video clip and the set of prompt embeddings for the training instance to generate a set of video embeddings. The video analysis system 130 applies the decoder to the set of video embeddings to generate an estimated output. The video analysis system 130 computes a loss function that indicates a difference between the estimated output and the desired output for a training instance. During the backpropagation step, the video analysis system 130 obtains one or more error terms from the loss function and backpropagates the terms to update parameters of the video encoder and/or the decoder. This process is repeated for other training instances and other reference videos in the training data until a convergence criterion is reached.

### Example Illustrations of Universal Video Assistant

The below are illustrations of the universal assistant for video, in accordance with one or more embodiments. The video analysis system 130 may train the video encoder and/or the decoder during a training process, and deploy the trained architecture in conjunction with one or more components to receive and process user queries on one or more videos.

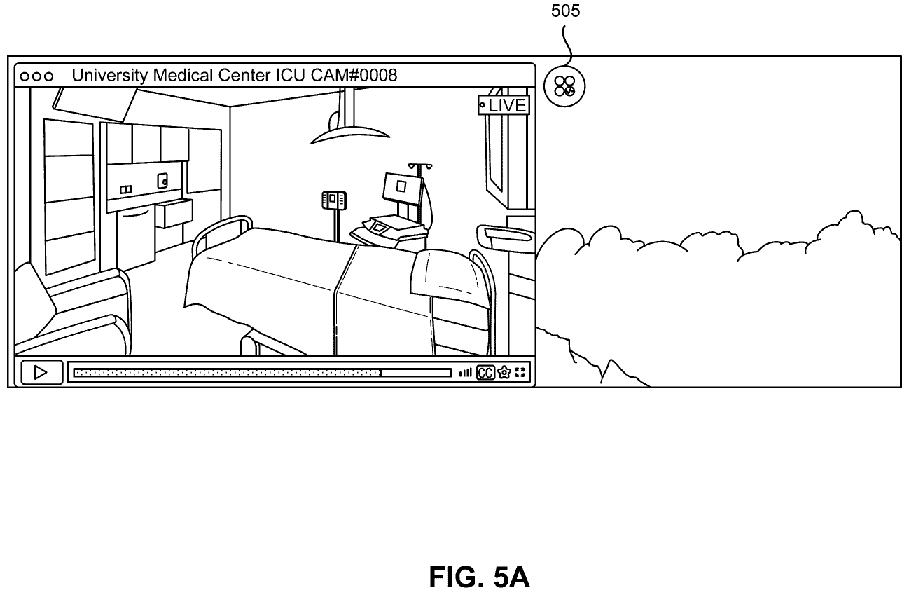

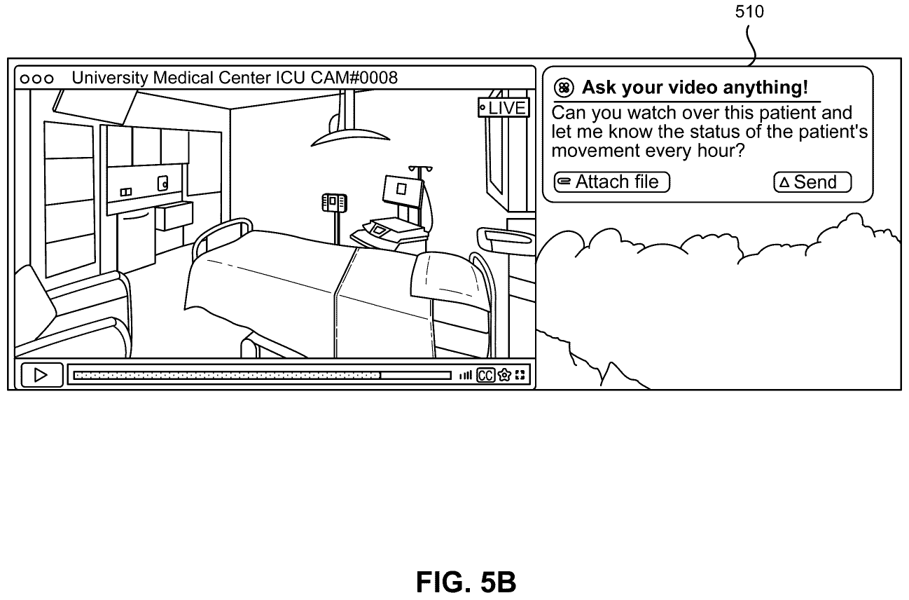

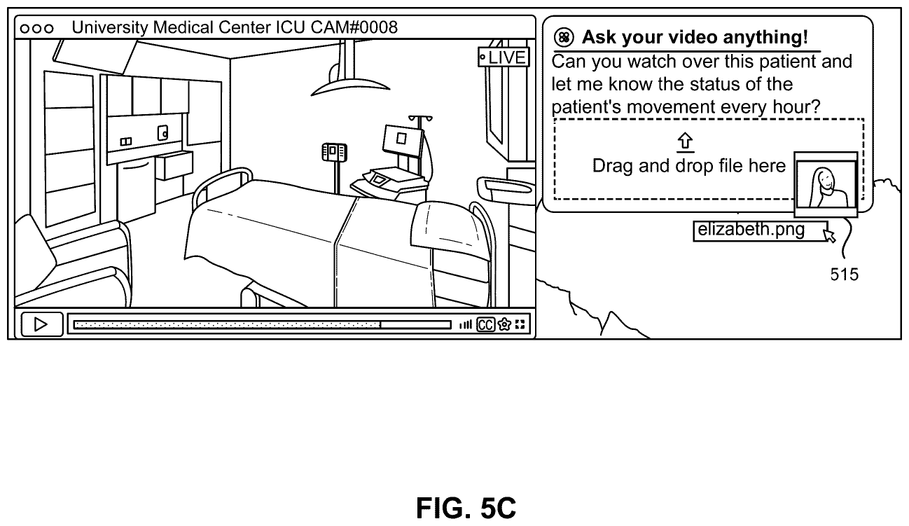

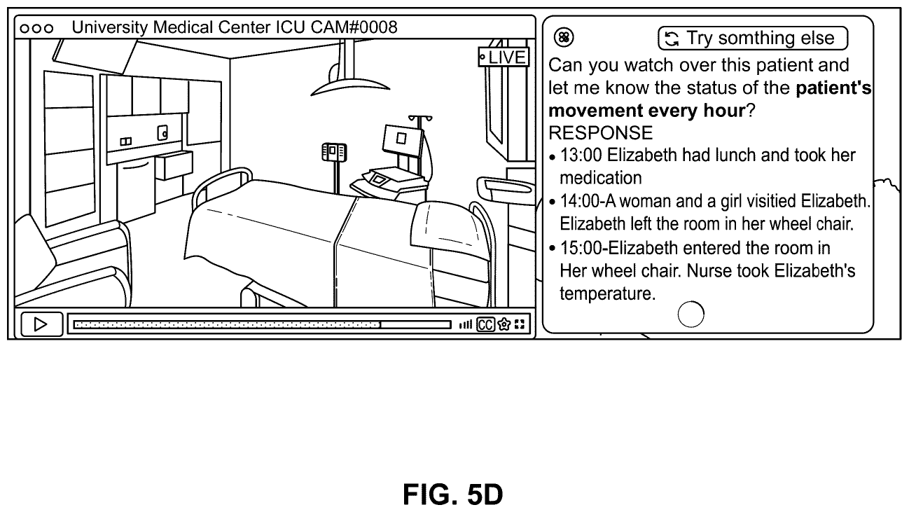

FIGS. 5A-5D illustrate example screenshots of interaction with the universal video assistant, in accordance with an embodiment. As shown in FIG. 5A, the universal video assistant when accessed by a user of the client device 116 may include a user interface configured as, for example, a button element 505, a dropdown element, and the like, that a user can interact (e.g., click, hover over) with to initiate a window to input a prompt. The reference video is a video monitoring a patient in a hospital room.

As shown in FIG. 5B, responsive to the user clicking the element 505, a window 510 is generated and the user inputs a prompt using the window. The example illustrated in FIG. 5B is a user query to watch over the patient and let the user know the patient's movement every hour. Thus, the user query includes a request to review the content of the video, and every hour, describe the patient's movement.

As shown in FIG. 5C, the user can provide an image 515 of the patient that the user is interested in monitoring as an image. Thus, the patient's image is provided as contextual information in the user query and is of a different data modality than the textual portion of the query.

As shown in FIG. 5D, responsive to receiving the user's query, the universal video assistant generates one or more responses by executing the video encoder and/or the decoder (e.g., of FIG. 2 or FIG. 4). For example, the video analysis system 130 may apply the video encoder to input data of a reference video or a video clip of the reference video to generate a set of video embeddings. The video analysis system 130 may apply a text encoder to a text portion of the user query to generate a set of text embeddings, a visual encoder to the visual or image portion of the user query to generate a set of visual embeddings, and an audio encoder to the audio portion of the user query to generate a set of audio embeddings. The video analysis system 130 applies the multi-modal encoder and/or the decoder to the set of video embeddings and the set of prompt embeddings to generate one or more outputs.

In the example shown in FIG. 5D, since the user query requests to generate the status of the patient every hour, a response may be generated every hour of the video. For example, the first response indicates “13:00-Elizabeth had lunch and took her medication,” thus, the response is generated with a time marker. In this manner, the universal video assistant may monitor patients and notify a user if there are any particular movements in the hour without the user having to manually review the video.

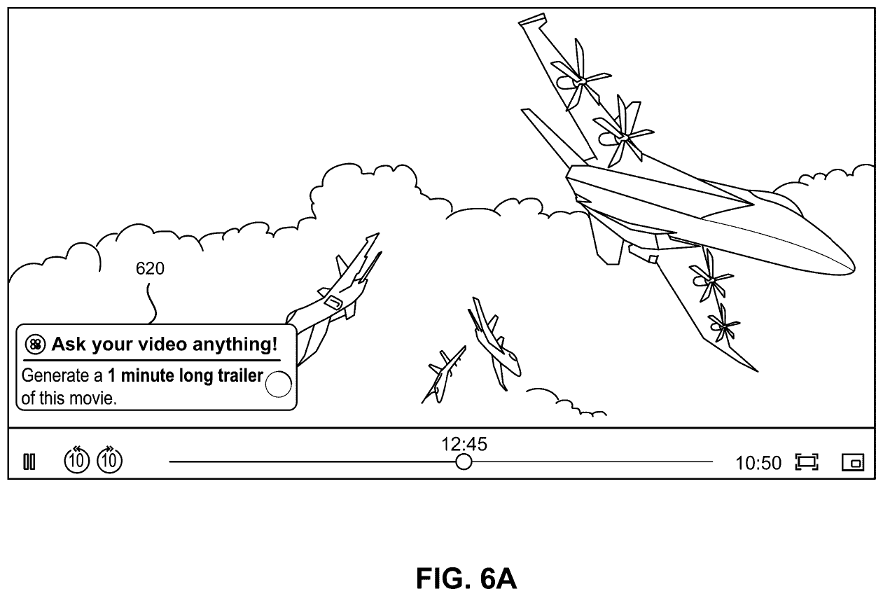

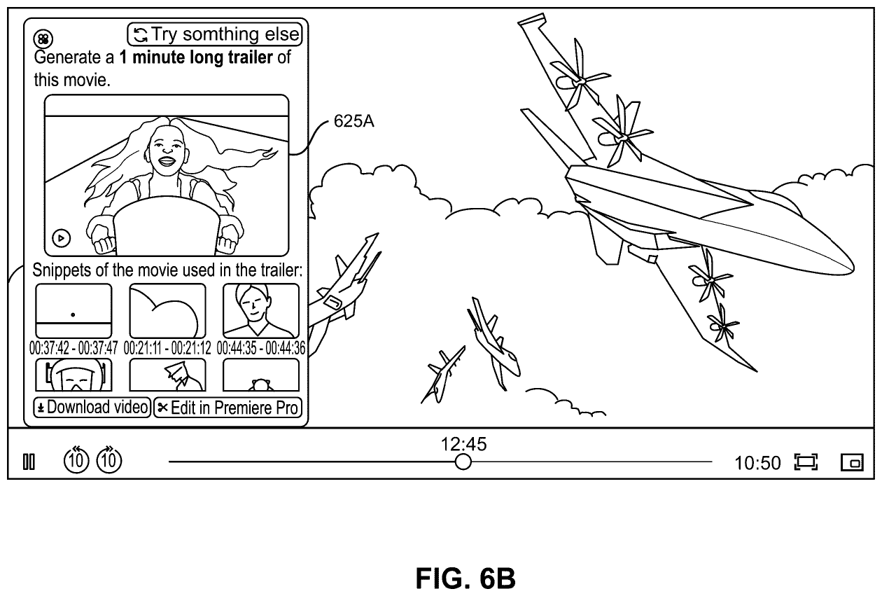

FIGS. 6A-6B illustrate example screenshots of interaction with the universal video assistant, in accordance with another embodiment. As shown in FIG. 6A, the reference video is a video of a movie. The example illustrated in FIG. 6A is a user query to create a one-minute long trailer of the movie, which is shown within the window element 620.

As shown in FIG. 6B, the universal video assistant generates a response that is a video, in particular, the requested one-minute trailer video of the movie. Moreover, the response also includes representative sub-clips 625A, . . . , 625N of the video that the universal video assistant extracted to generate the trailer of the video. This way, the universal video assistant can extract key scenes of a reference movie video and generate a trailer summarizing the key scenes.

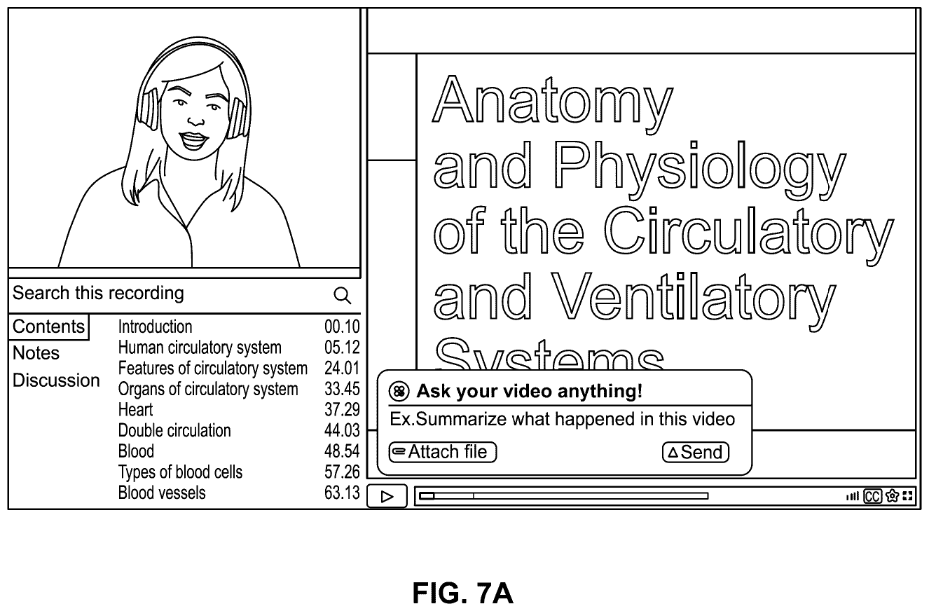

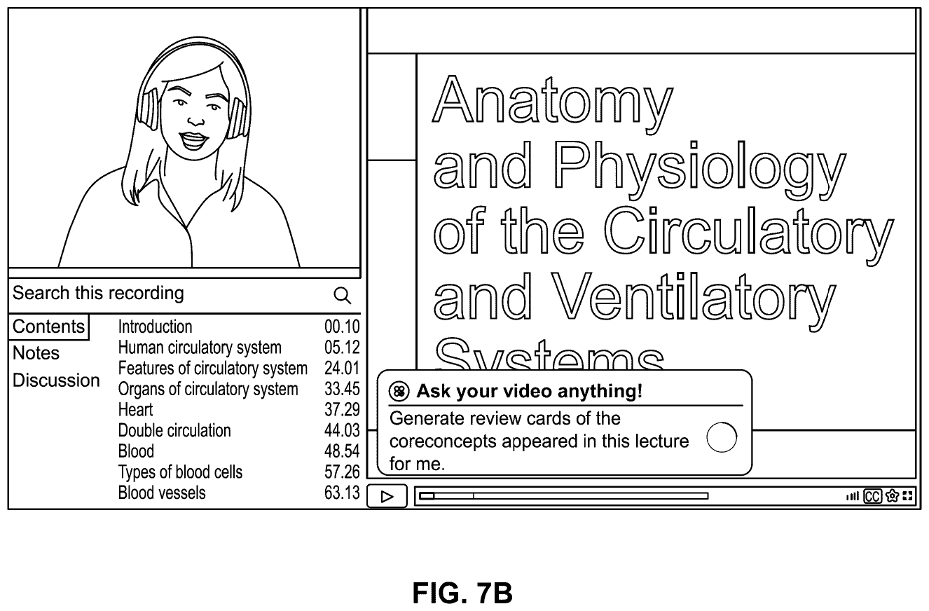

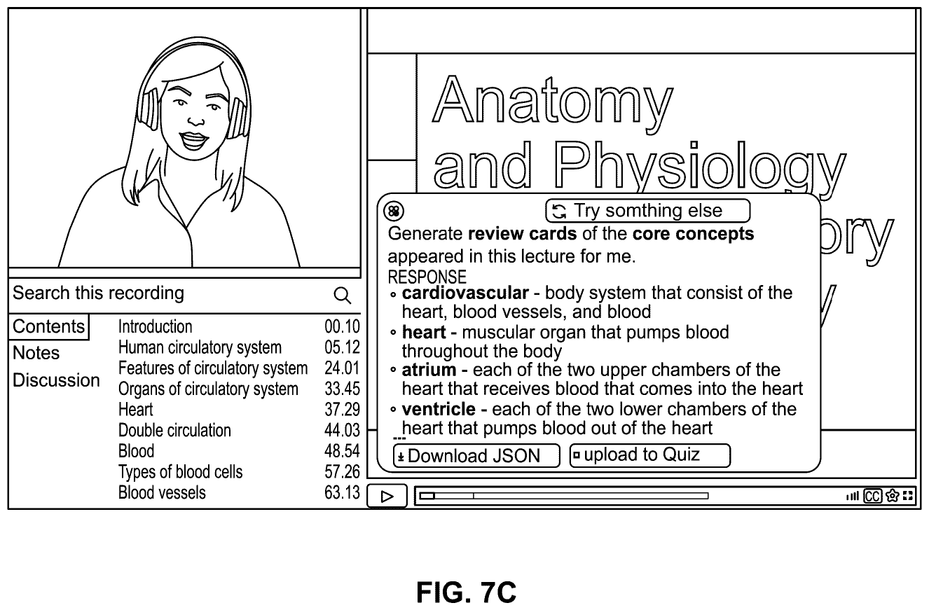

FIGS. 7A-7C illustrate example screenshots of interaction with the universal video assistant, in accordance with another embodiment. As shown in FIG. 7A, the reference video is a lecture on “Anatomy and Physiology of the Circulatory and Ventilatory Systems.”

As shown in FIG. 7B, the user query is to generate review cards of the core concepts appearing in the lecture video.

As shown in FIG. 7C, the universal video assistant generates a response that summarizes the core concepts of the lecture video in the form of review cards. For example, the first response indicates “cardiovascular-body system that consist of the heart, vessels, and blood,” and may also include other review cards heart, atrium, and ventricle. This way, the universal video assistant is capable of summarizing and generating review cards of concepts and topics that were covered in the lecture video, without a viewer having to generate the review cards manually.

### Generating Responses to User Queries Using Alignment Model and LLM

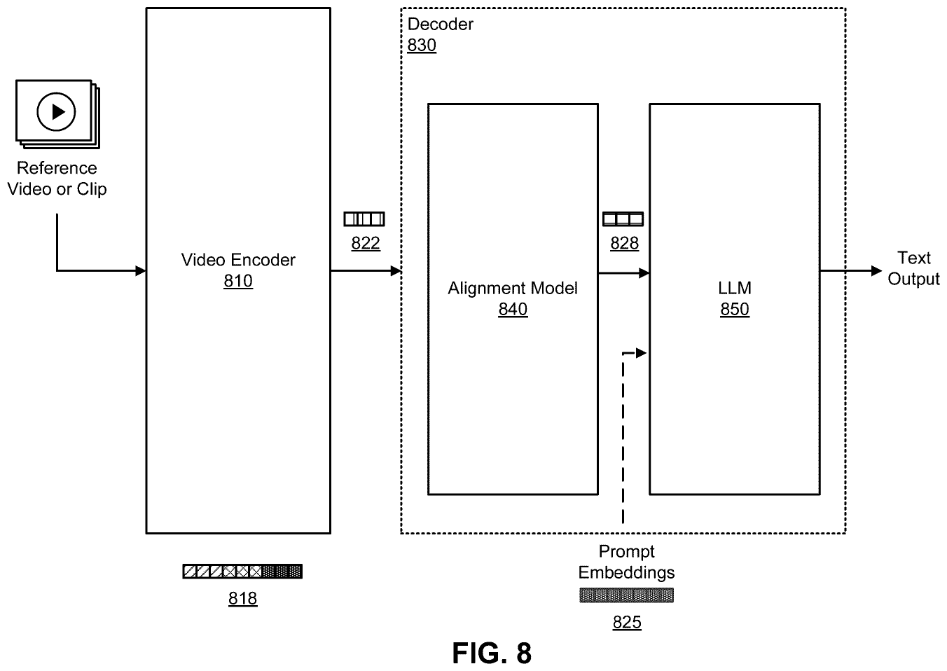

FIG. 8 illustrates an example inference process for generating responses to a user query using a video encoder 810 and/or a decoder 830 including an alignment model 840 and a LLM 850, in accordance with an embodiment. In one embodiment, the video encoder 810 is configured substantially similar or identical to the video encoder 210 of FIG. 2. The video encoder 810. The decoder 830 includes an alignment model 840 and a LLM 850. However, it is appreciated that in other embodiments, the video encoder 810 and/or the decoder 830 may include fewer or more components than that illustrated in FIG. 2.

As described above, the video encoder 810 is coupled to receive the frame data, audio data, and/or text data of a video or video clip and generate a set of video embeddings 822 numerically representing the video or video clip in a latent space. As described above, the video encoder 810 may also include individual modality encoders, similar to the visual encoder 212, audio encoder 214, and/or text encoder 216 described with respect to FIG. 2.

The alignment model 840 is coupled to receive the set of video embeddings 822 and generate a set of video-language-aligned embeddings 828. In particular, the alignment model 840 may transform or project the set of video embeddings 822 in a first latent space to the set of video-language-aligned embeddings 828 in a second latent space that is a latent space for text embeddings. In one embodiment, the alignment model 840 aims to bridge the set of video embeddings 822 with the LLM's 850 text domain. This allows the LLM to interpret the video embeddings 822 similarly to how it comprehends text tokens.

In one embodiment, the video analysis system 130 combines the set of prompt embeddings 825 and the set of video-language-aligned embeddings 828 to generate a combined tensor. In one instance, the set of prompt embeddings 825 are concatenated to the set of video-language-aligned embeddings 828 to generate a concatenated tensor. In another instance, the set of prompt embeddings 825 are interweaved with the set of video-language-aligned embeddings 828 to generate an interweaved tensor.

The LLM 850 is a large language model coupled to receive the set of video-language-aligned embeddings 828 and generate an output (e.g., text output). In one embodiment, the LLM 850 is configured as a transformer architecture. The LLM 850 may be pre-trained by another entity or by the video analysis system 130. In one embodiment, the LLM 850 may be trained on a large amount of data from various data sources. For example, the data sources include websites, articles, posts on the web, and the like. From this massive amount of data coupled with the computing power of LLMs, the LLM is able to perform various inference tasks and synthesize and formulate output responses based on information extracted from the training data.

The LLM 850 interprets the set of video-language-aligned embeddings 828 based on the prompt incorporating the user query. In one embodiment, the LLM 850 is coupled to receive the set of prompt embeddings 825 (i.e., which may be generated substantially similar to the process described in FIGS. 2 and 4) and the set of video-language-aligned embeddings 828 to generate an output. For example, the LLM 850 is applied to the combined tensor to generate the output. The LLM 850 leverages extensive knowledge base to interpret the video-language-aligned embeddings 828 based on the user query. The LLM 850 decodes the information into an output, that can be converted into coherent, human-readable text.

In one embodiment, the video analysis system 130 may receive a query from a user for a video. For example, the query may be received via an application programming interface (API) of the video analysis system 130. For example, a user query on an advertisement video may be “What kind of advertisement is this?” As another example, a user query on an interview video may be “Describe the main character in the video.” The video analysis system 130 generates a set of prompt embeddings 825 from the user query.

The video analysis system 130 obtains the video for the query. The video analysis system 130 may optionally apply segmentation techniques, such as scene boundary detection and/or key frame detection to identify a plurality of video clips from the video file. For example, given a 600 second video, the segmentation process may extract a plurality of video clips (3 s-10 s), (10 s-20 s), . . . , (578 s-594 s).

The video analysis system 130 applies the video encoder 810 and/or the decoder 830 to each video clip to generate a respective output to the user query for each video clip. In an alternative embodiment, the video analysis system 130 applies the video encoder 810 and/or the decoder 830 to the video (i.e., beyond one video clip) to generate an output to the user query that takes into account the entire context of the video.

In one embodiment, the video analysis system 130 generates dense descriptions of the video clips in the video using the trained video encoder 810 and/or decoder 830. Specifically, for each video clip, the video analysis system 130 applies the video encoder 810 to generate a set of video embeddings 822 for the video clip. The video analysis system 130 applies the alignment model 840 to the set of video embeddings 822 to generate a set of video-language-aligned embeddings 828 for the video clip. The video analysis system 130 applies the LLM 850 to the set of video-language-aligned embeddings 828 and optionally a set of prompt embeddings 825 to generate an output for the dense description. The set of prompt embeddings 825 may specify to “Generate a dense description of the video clip capturing key frames and events in the clip.”

As an example, the following dense descriptions may be generated for a plurality of video clips:
(3 s-10 s): A girl in a swimsuit applies sunscreen to her body while sitting on a chair outdoors. She discusses her preference for tanning oil, highlighting its benefits such as UV protection and hydration.
(10 s-20 s): A woman in a car is seen multitasking as she drives. She is eating food, talking on her phone, and even changing clothes while on the move. Despite these distractions, she manages to make a stop at a roadside shop before continuing her journey. Later, she enters a shopping mall and explores various clothing stores. [symbol]
(578 s-594 s): The woman in a white top and cap shares her love for hair accessories and her recent discovery of bows on her social media account. She shows off a cute hair bow she recently acquired and expresses her excitement to have her social media account back.

### Training Process of Alignment Model

As described in detail in conjunction with FIG. 2, the video analysis system 130 trains parameters for the video encoder and/or the decoder using training data. In one embodiment, for a reference video, the training data includes one or more training instances. A training instance generated for the video includes inputs and outputs. The input for the training instance includes the reference video or a reference video clip and a user query submitted for the video. The output for the training instance includes the expected or desired response to the user query given the contents of the reference video or video clip. As an example, a training instance can include a video clip and the desired response is the dense description of the clip in text.

For a forward pass step, the video analysis system 130 applies the video encoder to video clip of a training instance to generate a set of video embeddings. The video analysis system 130 applies the alignment model 940 to the set of video embeddings to generate a set of video-language-aligned embeddings. The video analysis system 130 applies the LLM 970 to the set of video-language-aligned embeddings and a set of prompt embeddings to generate the estimated output. The estimated output may represent an estimated clip description of the video clip. The video analysis system 130 computes a loss function indicating a difference between the estimated output and the desired output for the training instance. During the backpropagation step, the video analysis system 130 obtains one or more terms from the loss function and backpropagates the terms to update parameters of the video encoder and/or the decoder. This process is repeated for other training instances and other reference videos in the training data until a convergence criterion is reached.

In one embodiment, the parameters of the video encoder and the LLM (i.e., LLM 950) are frozen or substantially changed less during the training process while the parameters of the alignment model are updated. Therefore, the video encoder and the LLM may be pre-trained in a separate process. In one embodiment, during the backpropagation step, only the parameters of the alignment model are updated based on the loss function for that iteration. In another embodiment, the parameters of the video encoder and the LLM are also updated but with a significantly small learning rate compared to the learning rate of the alignment model. This way, the parameters of the alignment model learn to map the set of video embeddings to an LLM-aligned embedding in the latent space.

### Refining Clip Descriptions and Video-Level Information Through Feedback Loops

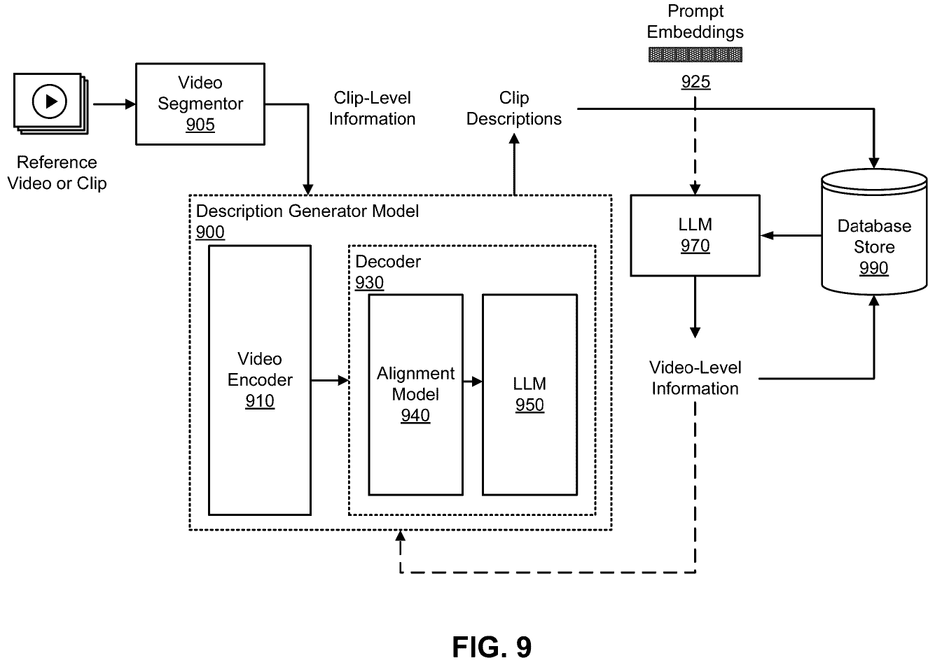

FIG. 9 illustrates generating clip descriptions using the video encoder 910 and/or the decoder 930 and generating responses using a LLM 970, in accordance with an embodiment. In one embodiment, the video encoder 910 is configured substantially similar or identical to the video encoder in FIG. 2, 4, or 8. The decoder 930 is configured substantially similar or identical to the decoder in FIG. 2, 4, or 8. The decoder 930 includes an alignment model 940 and a LLM 950.

In one embodiment, the video analysis system 130 generates clip descriptions as described in conjunction with FIG. 8 and stores the clip descriptions in a database store 990 for the video. In one embodiment, the LLM 970, which may be the same or different model from the LLM 950, is coupled to receive at least the set of prompt embeddings and the clip descriptions and generate an output for a given prompt. In one embodiment, the video analysis system 130 applies the LLM 970 to the dense clip descriptions and the set of prompt embeddings to generate a list of video-level text, including at least one of a title, hashtags, topic, summary, chapters, highlights, dense narrations, and the like of the video.

For example, returning to the example in FIG. 8, the video analysis system 130 applies the LLM 970 to the clip descriptions, user-specific information (e.g., “This is a video about my vlog.”), and a set of prompt embeddings representing a prompt. For example, the prompt may be “You are an excellent video summary generator. Given the dense clip descriptions <clip descriptions> and the video is <user-specific information>, generate a <title>, <title>, <topics>, <chapters>, <summary> of this video.”

As an example, the output from the LLM 970 may be:
Title: Summer Adventures: Sun, Shopping, and Memories
Topic: Vlog
Hashtags: #summer, #beach, . . .
Summary (6-10 sentences): This video is about my summer on the beach . . .
Chapters:
   (0 s-120 s): Summer beach exploration.
   (120 s-150 s): Shopping in the scene. [symbol]
   (560 s-600 s): Reflection of the day.
Highlights:
   (120 s-140 s): Shopping in the scene because she needs sandals.
Dense Narrations (30+ sentences)

In one embodiment, the video analysis system 130 performs one or more feedback loops to repeat the process of generating clip descriptions using the video-level information generated at the previous iteration. The video analysis system 130 applies the video encoder 910 and/or the decoder 930 to the input data of the video clips to re-generate the dense clip descriptions, but components of the video encoder 910 and/or the decoder 930 are also coupled to receive not only the inputs described above in conjunction with FIGS. 2, 4, and 8, but also the video-level information that was generated at a previous iteration.

The video analysis system 130 generates a set of feedback embeddings that are embeddings that represent the video-level information generated by, for example, the LLM 970. For example, the video analysis system 130 may generate embeddings for the title, topic, hashtags, chapters, highlights generated above. The set of feedback embeddings may be combined with inputs to the video encoder 910 or the decoder 930 when re-generating the clip descriptions.

For example, the set of feedback embeddings is combined with the set of visual embeddings, the audio embeddings, the text embeddings generated by individual modality encoders in the video encoder 910 and the video analysis system 130 may apply the multi-modal encoder to the combined tensor to generate a set of video embeddings. As another example, the set of feedback embeddings is combined with the set of video embeddings and the video analysis system 130 may apply the alignment model 940 to the combined tensor to generate the set of video-language-alignment embeddings. As yet another example, the set of feedback embeddings is combined with the set of video-language-alignment embeddings and the video analysis system 130 applies the LLM 950 to generate the output. The updated clip descriptions are then used again to re-generate the video-level information using the LLM 970.

This process is repeated for one or more next iterations until the model determines the generated output satisfies a performance criterion. In this manner, the clip descriptions incorporate the high-level context of the video-level information when re-generated, and can further refine the clip descriptions in a more accurate way. The video analysis system 130 stores the final clip descriptions as well as the final video-level information (e.g., title, topic, hashtags, chapters, summary, highlights, dense narrations) in the database store 990.

The video analysis system 130 may receive a custom user query (e.g., “What is this video about?”) from a user of a client device 116. In one embodiment, the video analysis system 130 generates a set of prompt embeddings 925 incorporating the user query. The LLM 970 is applied to the set of prompt embeddings 925 and/or the clip descriptions and video-level information of the video stored in the database store 990 to generate an output. The output is used to synthesize the response to the user query.

### Example Illustrations of Clip Descriptions and Video-Level Information

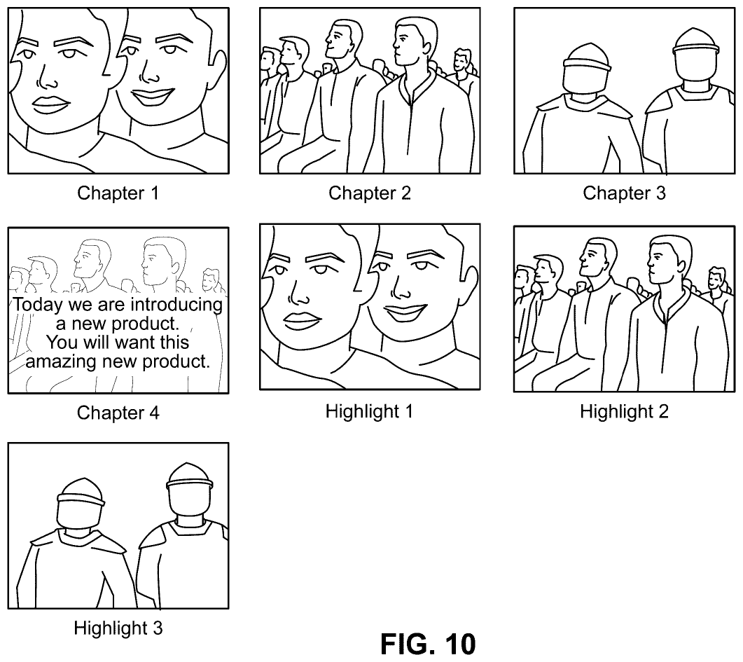

FIG. 10 illustrates example screenshots of chapters generated using the clip description model, in accordance with an embodiment. In one example described herein, the video analysis system 130 generates clip descriptions and video-level information for an advertisement video using the process of FIGS. 8 and 9. The following are example video-level information generated for the advertisement video:
Title: The Revolution Unveiled: A Journey through Ideology, Excitement, and Innovation
Topic: Action.
Hashtags: #information-purification-convictives, #garden-of-pure-ideology, #underground-tunnel, #guns, #live-event, #energy-and-excitement, #woman-in-white-attire, #animated-character, #martial-arts-skills, #dangerous-hallway, #armed-men, #Computer, #revolutionary-potential
Summary:
   The video takes us into the underground world, where a group of individuals move through dark tunnels, armed with guns, as they celebrate the first anniversary of the Information Purification Convictives. They have created a pure ideology, something unprecedented in history. The energy and excitement of a live event come alive as we see people engaged in various activities. A woman dressed in white leads the way, followed by others who join in, their enthusiasm palpable. A captivating display on a large screen captures the attention of the crowd, adding to the overall excitement. Amidst this chaos, we witness a skilled martial artist, the same woman in white, navigating a dangerous hallway while being pursued by armed men, showcasing her incredible combat skills. The scene is dramatically lit, creating a sense of tension and anticipation. The video concludes with the introduction of the company's groundbreaking product, promising a future that breaks away from the conformity of 1984. It is a mesmerizing journey into the underground revolution, a mix of ideology, thrilling action, and a glimpse of the future.
Chapters:
   Creating a Garden of Pure Ideology (00:00:00-00:00:15) (Represented by “Frame 1”): The video begins with a group of individuals moving through an underground tunnel, armed with guns, as they celebrate the first anniversary of the Information Purification Convictives. They discuss the creation of a garden of pure ideology.
   Energy and Excitement of a Live Event (00:00:15-00:00:30) (Represented by “Frame 2”): The video captures the energy and excitement of a live event, with people engaged in various activities. A woman in white attire leads the way, followed by others who join in. Captivating images displayed on a large screen add to the overall excitement and entertainment.
   Display of Incredible Combat Skills (00:00:30-00:00:45) (Represented by “Frame 3”): A woman in white attire navigates a dangerous hallway while being pursued by armed men. She showcases her incredible martial arts skills in a dramatically lit area, captivating the viewer with her agility and combat techniques.
   Introduction of the Product (00:00:45-00:01:00) (Represented by “Frame 4”): The video concludes with the introduction of the company's groundbreaking product. This new technology promises a future that breaks away from the conformity of 1984, offering viewers a glimpse of the possibilities that lie ahead.
Highlights:
   00:00:00-00:00:15 (Represented by “Highlight 1”): The video showcases a group of individuals moving through an underground tunnel, some of them armed with guns.
   00:00:15-00:00:30 (Represented by “Highlight 2”): The video captures the energy and excitement of a live event, with people engaged in various activities.
   00:00:30-00:00:45 (Represented by “Highlight 3”): The video showcases a woman in white attire who walks through a dangerous hallway while being pursued by armed men.
      Attention Mechanism in Video Encoder and/or Decoder

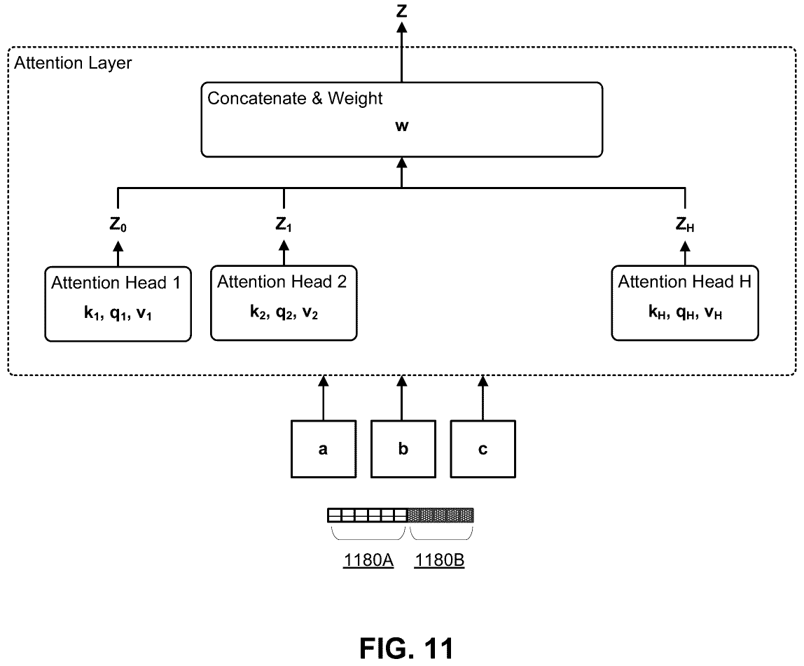

FIG. 11 illustrates an architecture of an attention block with multi-head attention, in accordance with an embodiment. As described above, one or more components of the video encoder and/or the decoder described herein are configured as a transformer architecture that includes attention blocks optionally with a multi-headed structure. For example, the multi-modal encoder, the LLM, and the like may be configured as a transformer architecture.

As shown in FIG. 11, an attention block with a multi-headed structure is coupled to receive an input a for queries, an input b for keys, and an input c for values, and generate a set of attention representations. Specifically, the multi-headed structure includes a plurality of attention heads. Each attention head is associated with its own key matrix Wₖ, query matrix W_{q}, and value matrix Wᵥ. The attention head is coupled to receive the input a, the input b, and the input c and generate a respective output. Specifically, the attention layer applies the respective query matrix W_{q} to the input a to generate a query q, the respective key matrix Wₖ to the input key b to generate a key k, and the respective value matrix Wᵥ to the input c to generate a value v. The query is combined with the key to generate an attention, and the attention is combined with the value to generate an output tensor Z (Z₀, Z₁, . . . , Z_{H} or concatenated tensor Z).

This process is performed for each separate attention head. For example, the attention block in FIG. 11 includes attention heads 1, 2, . . . , H, where an attention head i is associated with its own key matrix Wₖᵢ, query matrix W_{qi}, and value matrix Wᵥᵢ. An attention head i is coupled to receive the input a, the input b, and the input c to generate a respective output zᵢ. The attention representation for the attention block z is generated by concatenating the outputs z₁, z₂, . . . , z_{H} and applying an output matrix w to the concatenated outputs.

In one embodiment, the inputs (e.g., each of the inputs a, b, c in FIG. 11) are obtained from a set of embeddings extracted from the video data and/or a set of embeddings extracted from the prompt embeddings. As shown in FIG. 11, the input tensor (as one concatenated tensor) 1180 include one or more embeddings 1180A obtained from video data, and one or more embeddings 1180B obtained from the prompt embeddings. In one embodiment, the attention layer is included in the decoder 230 of FIG. 2, and the inputs 1180A are obtained from the set of video embeddings 222, and the inputs 1180B are obtained from the set of prompt embeddings 225 via one or more operations. For example, the inputs 1180A may be a set of embeddings obtained by performing a linear projection layer on the set of video embeddings 222, and the inputs 1180B may be a set of embeddings obtained by performing a linear projection layer on the set of prompt embeddings 225.

In one embodiment, the attention layer is included in the multi-modal encoder 420 of FIG. 4, and the inputs 1180A are obtained from the set of individual modality embeddings from the visual encoder 412, audio encoder 414, and text encoder 416, and the inputs 1180B are obtained from the set of prompt embeddings 425. In one embodiment, the attention layer is included in the LLM 850 of FIG. 8, and the inputs 1180A are obtained from the set of video-language-aligned embeddings 828 form the alignment model 840, and the inputs 1180B are obtained from the set of prompt embeddings 825. Alternatively, the set of prompt embeddings 825 may be input to the alignment model 840, and the inputs 1180A may be obtained from the set of video embeddings 822, and the inputs 1180B are obtained from the set of prompt embeddings 825.

As described above in conjunction with FIGS. 1 and 2, each of the key matrices Wₖᵢ, query matrices W_{qi}, value matrices Wᵥᵢ may be represented by a set of parameters in any form, not limited to matrix operations. For example, each attention head may include one or more neural network layers (e.g., fully connected layer, skip layer, etc.) that are coupled to receive the input a, input b, input c and generate the respective output zᵢ by applying a set of parameters for the neural network layers to the input a, input b, input c. The attention block may further include one or more neural network layers (e.g., fully connected layer, skip layer, etc.) coupled to receive the concatenated outputs z₁, z₂, . . . , Z_{H} and generate the set of attention representations by applying a set of parameters for the neural network layers to the concatenated outputs. Thus, in one embodiment, when a multi-headed structure is applied to an attention layer, the video analysis system 130 may also initialize parameters of the transformer architecture including parameters of multi-attention blocks including each respective key matrix Wₖᵢ, query matrix W_{qi}, and value matrix Wᵢ of an attention head.

Method of Generating a Query Response Using a Video Encoder and/or Decoder

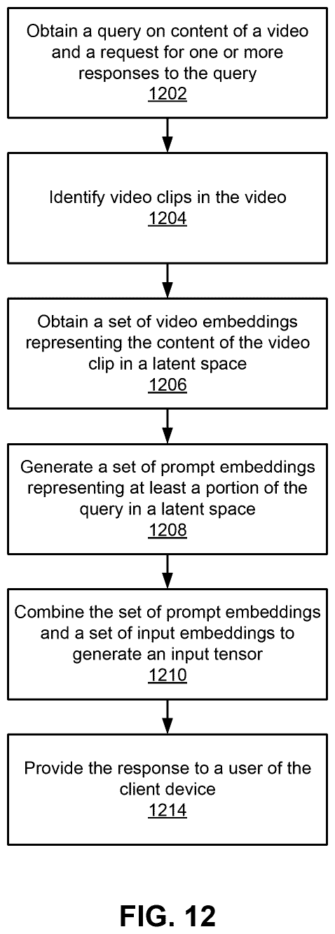

FIG. 12 illustrates a method of generating a response to a query using a video encoder and/or decoder, in accordance with an embodiment. The video analysis system 130 obtains 1202 a query on content of a video and a request for one or more responses to the query. The video analysis system 130 identifies 1204 one or more video clips in the video, each video clip including a segment of the video. The video analysis system 130 obtains 1206 a set of video embeddings representing the content of a video clip in a latent space. In one embodiment, the set of video embeddings are generated by extracting frame data, audio data, or text data from the video content, and applying a machine-learned video encoder to the frame data, the audio data, or the text data to generate the set of video embeddings.

The video analysis system 130 generates 1208 a set of prompt embeddings representing at least a portion of the query in a latent space. The video analysis system 130 combines 1210 the set of prompt embeddings and a set of input embeddings to generate an input tensor. The video analysis system 130 applies 1212 at least a component of a machine-learned decoder to the input tensor to generate an output including a set of output embeddings. The video analysis system 130 converts the set of output embeddings into a response to the query based on the video content of the video clip. The video analysis system 130 provides 1214 the response to a user of the client device.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method, comprising:
obtaining a query on content of a video and a request for one or more responses to the query;
identifying one or more video clips in the video, each video clip including a segment of the video;
obtaining a set of video embeddings representing the content of a video clip in a latent space, wherein the set of video embeddings are generated by:
extracting frame data, audio data, or text data from the video content, and
applying a machine-learned video encoder to the frame data, the audio data, or the text data to generate the set of video embeddings;
generating a set of prompt embeddings representing at least a portion of the query in a latent space;
combining the set of prompt embeddings and a set of input embeddings to generate an input tensor; and
applying at least a component of a machine-learned decoder to the input tensor to generate an output including a set of output embeddings;
converting the set of output embeddings into a response to the query based on the video content of the video clip; and
providing the response to a user of the client device.

2. The method of claim 1, wherein applying the machine-learned video encoder further comprises:
applying a visual encoder to the frame data to generate a set of visual embeddings,
applying an audio encoder to the audio data to generate a set of audio embeddings,
applying a text encoder to the text data to generate a set of text embeddings; and
applying a multi-modal encoder to the set of visual embeddings, the set of audio embeddings, and the set of text embeddings to generate a set of video embeddings for the video clip.

3. The method of claim 1, wherein the frame data, the audio data, or the text data is associated with one or more time markers, each time marker representing a respective time stamp of when data occurred during the video clip, and wherein the response includes at least one time marker for a time stamp of the video clip that is relevant to the query.

4. The method of claim 1, wherein the frame data, the audio data, or the text data is associated with one or more spatial markers, each spatial marker representing a respective spatial region of data occurring during the video clip, and wherein the response includes at least one spatial marker for a spatial region of the video clip that is relevant to the query.

5. The method of claim 1, wherein the decoder further includes a machine-learned alignment model and a machine-learned language model.

6. The method of claim 5, further comprising:
applying the machine-learned alignment model to the set of video embeddings to generate a set of video-language-aligned embeddings, and wherein the set of input embeddings are the set of video-language-aligned embeddings,
wherein applying the component of the machine-learned decoder comprises applying the machine-learned language model to the input tensor to generate the set of output embeddings.

7. The method of claim 1, wherein the set of input embeddings are the set of video embeddings,
wherein applying the component of the machine-learned decoder comprises applying the machine-learned alignment model to the input tensor to generate a set of video-language-aligned embeddings, the further comprising:
applying the machine-learned language model the set of video-language-aligned embeddings to generate the set of output embeddings.

8. The method of claim 5, wherein the query is to generate a description of the video clip in text, and wherein the response is a clip description of the video clip, the method further comprising:
for each video clip in the one or more video clips, generating clip descriptions for the video clip; and
storing the clip descriptions for the one or more video clips in a datastore.

9. The method of claim 8, further comprising:
applying the machine-learned language model or a second machine-learned language model to the clip descriptions for the one or more video clips to generate video-level information for the video;
applying at least a portion of the machine-learned decoder to a second set of video embeddings to update the clip description of the video clip, wherein applying at least the portion of the machine-learned decoder comprises including the video-level information in a set of inputs to the machine-learned alignment model or a set of inputs to the machine-learned language model.

10. The method of claim 1, wherein the video encoder or the decoder includes a transformer architecture including one or more attention layers, each attention layer coupled to receive a set of inputs and generate a query, a key, a value, and generate an attention output.

11. A non-transitory computer readable storage medium comprising stored program code instructions, the instructions when executed causes one or more processing systems to:
obtain a query on content of a video and a request for one or more responses to the query;
identify one or more video clips in the video, each video clip including a segment of the video;
obtain a set of video embeddings representing the content of a video clip in a latent space, wherein the set of video embeddings are generated by:
extracting frame data, audio data, or text data from the video content, and
applying a machine-learned video encoder to the frame data, the audio data, or the text data to generate the set of video embeddings;
generate a set of prompt embeddings representing at least a portion of the query in a latent space;
combine the set of prompt embeddings and a set of input embeddings to generate an input tensor; and
apply at least a component of a machine-learned decoder to the input tensor to generate an output including a set of output embeddings;
convert the set of output embeddings into a response to the query based on the video content of the video clip; and
provide the response to a user of the client device.

12. The non-transitory computer readable storage medium of claim 11, wherein the instructions further cause the one or more processing systems to:
apply a visual encoder to the frame data to generate a set of visual embeddings,
apply an audio encoder to the audio data to generate a set of audio embeddings,
apply a text encoder to the text data to generate a set of text embeddings; and
apply a multi-modal encoder to the set of visual embeddings, the set of audio embeddings, and the set of text embeddings to generate a set of video embeddings for the video clip.

13. The non-transitory computer readable storage medium of claim 11, wherein the frame data, the audio data, or the text data is associated with one or more time markers, each time marker representing a respective time stamp of when data occurred during the video clip, and wherein the response includes at least one time marker for a time stamp of the video clip that is relevant to the query.

14. The non-transitory computer readable storage medium of claim 11, wherein the instructions further cause the one or more processing systems to, wherein the frame data, the audio data, or the text data is associated with one or more spatial markers, each spatial marker representing a respective spatial region of data occurring during the video clip, and wherein the response includes at least one spatial marker for a spatial region of the video clip that is relevant to the query.

15. The non-transitory computer readable storage medium of claim 11, wherein the decoder further includes a machine-learned alignment model and a machine-learned language model.

16. The non-transitory computer readable storage medium of claim 15, wherein the instructions further cause the one or more processing systems to:
apply the machine-learned alignment model to the set of video embeddings to generate a set of video-language-aligned embeddings, and wherein the set of input embeddings are the set of video-language-aligned embeddings,
wherein the instructions further cause the one or more processing systems to apply the machine-learned language model to the input tensor to generate the set of output embeddings.

17. The non-transitory computer readable storage medium of claim 11, wherein the set of input embeddings are the set of video embeddings,
wherein the instructions further cause the one or more processing systems to apply the machine-learned alignment model to the input tensor to generate a set of video-language-aligned embeddings, and
apply the machine-learned language model the set of video-language-aligned embeddings to generate the set of output embeddings.

18. The non-transitory computer readable storage medium of claim 15, wherein the query is to generate a description of the video clip in text, and wherein the response is a clip description of the video clip, the instructions further causing the one or more processing systems to:
for each video clip in the one or more video clips, generate clip descriptions for the video clip; and
store the clip descriptions for the one or more video clips in a datastore.

19. The non-transitory computer readable storage medium of claim 18, wherein the instructions further cause the one or more processing systems to:
apply the machine-learned language model or a second machine-learned language model to the clip descriptions for the one or more video clips to generate video-level information for the video;
apply at least a portion of the machine-learned decoder to a second set of video embeddings to update the clip description of the video clip, wherein applying at least the portion of the machine-learned decoder comprises including the video-level information in a set of inputs to the machine-learned alignment model or a set of inputs to the machine-learned language model.

20. The non-transitory computer readable storage medium of claim 11, wherein the video encoder or the decoder includes a transformer architecture including one or more attention layers, each attention layer coupled to receive a set of inputs and generate a query, a key, a value, and generate an attention output.
